(19) United States
(12) Patent Application Publication
(10) Pub. No.: US 2025/0145525 A1
(43) Pub. Date: May 8, 2025

(54) GROUT OR CAULK WITH PHOSPHORESCENCE

(71) Applicant: BARBARA A. JOHNSON, QUEENS VILLAGE, NY (US)

(72) Inventor: BARBARA A. JOHNSON, QUEENS VILLAGE, NY (US)

(21) Appl. No.: 18/503,519

(22) Filed: Nov. 7, 2023

(51) Int. Cl. C04B 14/36; C04B 28/02; C04B 103/54; C04B 111/00; C04B 111/80; C09K 11/02; C09K 11/56; C09K 11/64

(52) U.S. Cl. CPC C04B 14/36; C04B 28/02; C09K 11/02; C09K 11/565; C09K 11/643; C04B 2103/54; C04B 2111/00637; C04B 2111/807

(57) ABSTRACT

The viscous building material with phosphorescence is a chemical compound. The viscous building material with phosphorescence is formed as a viscous colloid. The viscous building material with phosphorescence is applied as a viscous fluid between two objects. The viscous building material with phosphorescence performs a structural function selected from the group consisting of: a) forming a fluid impermeable seal between the two objects; and, b) forming an adhesive seal that holds the two objects in a fixed position relative to each other. The viscous building material with phosphorescence illuminates in the dark to form a beacon. The viscous building material with phosphorescence incorporates a structural compound and a phosphorescent compound. The structural compound and the phosphorescent compound are mixed to form the viscous colloid of the viscous building material with phosphorescence.

### CROSS REFERENCES TO RELATED APPLICATIONS

Not Applicable

### STATEMENT REGARDING FEDERALLY SPONSORED RESEARCH

Not Applicable

### REFERENCE TO APPENDIX

Not Applicable

### BACKGROUND OF THE INVENTION

### Field of the Invention

The present invention relates to the field of mixing high-viscosity liquids with solids. (B01F23/57)

### Summary of Invention

The viscous building material with phosphorescence is a chemical compound. The viscous building material with phosphorescence is a composition of matter. The viscous building material with phosphorescence is formed as a viscous colloid. The viscous building material with phosphorescence is applied as a viscous fluid between two objects. The viscous building material with phosphorescence performs a structural function selected from the group consisting of: a) forming a fluid impermeable seal between the two objects; and, b) forming an adhesive seal that holds the two objects in a fixed position relative to each other. The viscous building material with phosphorescence illuminates in the dark to form a beacon. The viscous building material with phosphorescence comprises a structural compound and a phosphorescent compound. The structural compound and the phosphorescent compound are mixed to form the viscous colloid of the viscous building material with phosphorescence.

These together with additional objects, features and advantages of the viscous building material with phosphorescence will be readily apparent to those of ordinary skill in the art upon reading the following detailed description of the presently preferred, but nonetheless illustrative, embodiments when taken in conjunction with the accompanying drawings.

In this respect, before explaining the current embodiments of the viscous building material with phosphorescence in detail, it is to be understood that the viscous building material with phosphorescence is not limited in its applications to the details of construction and arrangements of the components set forth in the following description or illustration. Those skilled in the art will appreciate that the concept of this disclosure may be readily utilized as a basis for the design of other structures, methods, and systems for carrying out the several purposes of the viscous building material with phosphorescence.

It is therefore important that the claims be regarded as including such equivalent construction insofar as they do not depart from the spirit and scope of the viscous building material with phosphorescence. It is also to be understood that the phraseology and terminology employed herein are for purposes of description and should not be regarded as limiting.

### BRIEF DESCRIPTION OF DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the appended claims.

FIG. 1 is a detail view of an embodiment of the disclosure.

FIG. 2 is an in-use view of an embodiment of the disclosure.

FIG. 3 is an in-use view of an embodiment of the disclosure.

FIG. 4 is a detail view of an embodiment of the disclosure.

### DETAILED DESCRIPTION OF THE EMBODIMENT

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description.

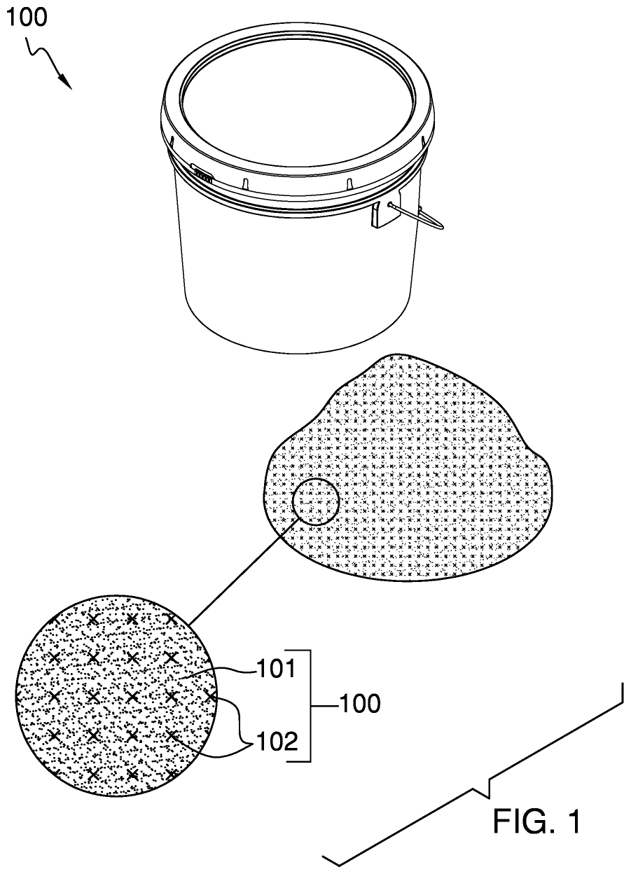

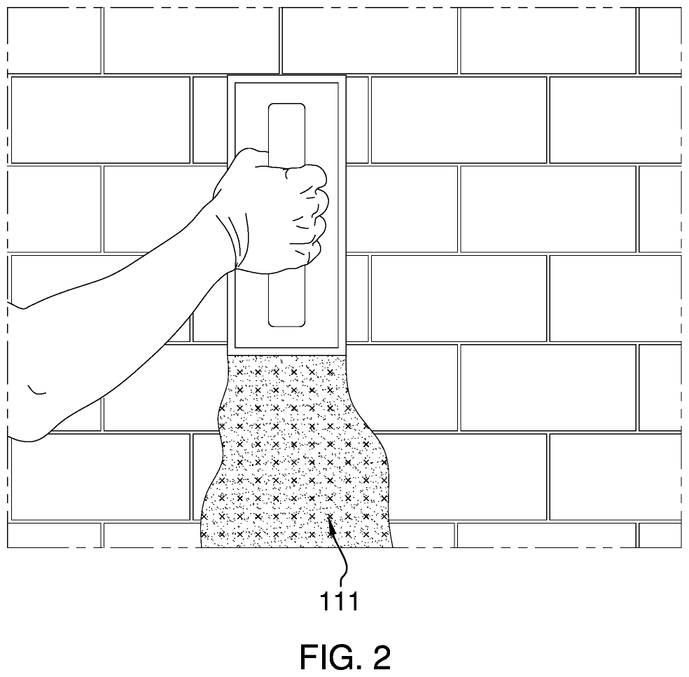

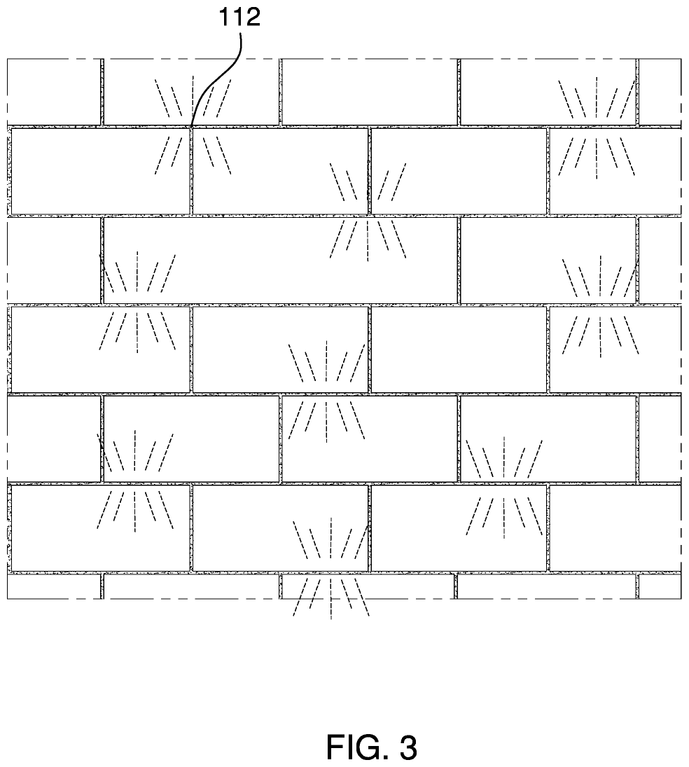

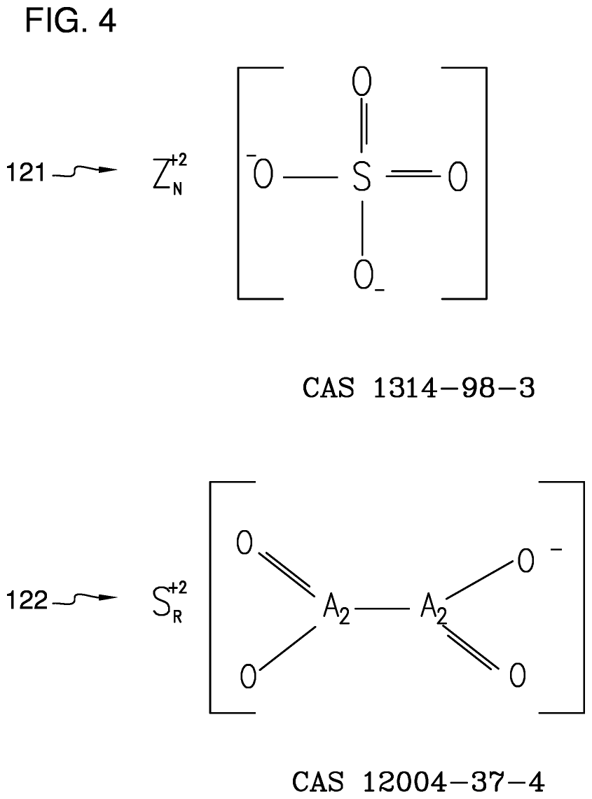

Detailed reference will now be made to one or more potential embodiments of the disclosure, which are illustrated in FIGS. 1 through 4.

The viscous building material with phosphorescence 100 (hereinafter invention) is a chemical compound. The invention 100 is a composition of matter. The invention 100 is formed as a viscous colloid. The invention 100 is applied as a viscous fluid between two objects. The invention 100 performs a structural function selected from the group consisting of: a) forming a fluid impermeable seal between the two objects; and, b) forming an adhesive seal that holds the two objects in a fixed position relative to each other. The invention 100 illuminates in the dark to form a beacon. The invention 100 comprises a structural compound 101 and a phosphorescent compound 102. The structural compound 101 and the phosphorescent compound 102 are mixed to form the viscous colloid of the invention 100.

The structural compound 101 is a chemical compound. The structural compound 101 is a viscous compound. The structural compound 101 is the compound of the invention 100 that performs the structural function of the invention 100. The structural compound 101 is selected from the group consisting of: a) forming a fluid impermeable seal between the two objects; and, b) forming an adhesive seal that holds the two objects in a fixed position relative to each other. The phosphorescent pigment 102 is added to the structural compound 101 to form the viscous colloid of the invention 100. The phosphorescent pigment 102 forms a colloidal suspension within the structural compound 101. The structural compound 101 is selected from the group consisting of: a) a cement structure 111; and, b) a polymer structure 112.

The cement structure 111 is the structure that forms an adhesive seal that holds two objects in a fixed position relative to each other. The cement structure 111 is formed from a binding material and an optional aggregate material. The cement structure 111 is a fluid phase viscous compound that is capable of flow. The cement structure 111 changes into a solid phase compound when exposed to the environment.

The polymer structure 112 is the structure that forms a fluid impermeable seal between two objects. The polymer structure 112 is formed from a polymer. The polymer structure 112 is a fluid phase viscous compound that is capable of flow. The polymer structure 112 changes into a solid phase compound when exposed to the environment. The phosphorescent pigment 102 is a phosphorescent material. The phosphorescent pigment 102 is a bulk solid compound. The phosphorescent pigment 102 is mixed directly into the structural compound 101. The molecular structure of the phosphorescent pigment 102 absorbs electromagnetic radiation from the environment. The phosphorescent pigment 102 releases the absorbed electromagnetic radiation back into the environment as electromagnetic radiation over time. The phosphorescent pigment 102 is selected such that the phosphorescent pigment 102 continues to release electromagnetic radiation after the phosphorescent pigment 102 is no longer exposed to electromagnetic radiation from the environment.

The phosphorescent pigment 102 is selected from the group consisting of: a) a zinc sulfide (CAS: 1314-98-3) 121; and, b) a strontium aluminate (CAS: 12004-37-4) 122.

The zinc sulfide (CAS: 1314-98-3) 121 is an ionic compound. The zinc sulfide (CAS: 1314-98-3) 121 is formed from bonding zinc with sulfate. The zinc sulfide (CAS: 1314-98-3) 121 exists in a bulk solid phase. The zinc sulfide (CAS: 1314-98-3) 121 is mixed into the structural compound 101. The zinc sulfide (CAS: 1314-98-3) 121 is a phosphorescent material. The zinc sulfide (CAS: 1314-98-3) 121 is used to release a red to orange phosphorescence from the invention 100.

The strontium aluminate (CAS: 12004-37-4) 122 is an ionic compound. The strontium aluminate (CAS: 12004-37-4) 122 is formed from bonding strontium with aluminum oxide. The strontium aluminate (CAS: 12004-37-4) 122 exists in a bulk solid phase. The strontium aluminate (CAS: 12004-37-4) 122 is mixed into the structural compound 101. The strontium aluminate (CAS: 12004-37-4) 122 is a phosphorescent material. The strontium aluminate (CAS: 12004-37-4) 122 is used to release a green to blue phosphorescence from the invention 100.

The following definitions were used in this disclosure:

Beacon: As used in this disclosure, a beacon refers to a detectable signal that draws the attention of a person or a device to a location. A beacon is commonly used as a guide to the location or as a warning signal about the location. A beacon that draws the attention of a person using an audible signal is called a siren.

Bulk Solid: As used in this disclosure, a bulk solid is a material that is formed from an accumulation of discrete particles. While the discrete particles of the bulk solid are solid materials, in aggregate the physical performance of bulk solid will exhibit fluid characteristics such as flow or taking 8 the shape of a container.

Caulk and Grout: As used in this disclosure, caulk and grout are building materials that are formed as viscous colloids. Caulk is applied as a viscous fluid between two objects to form a fluid impermeable seal between the two objects. Grout is applied as a viscous fluid between two objects to form an adhesive seal that holds the two objects in a fixed position relative to each other.

Cement and Concrete: As used in this disclosure, concrete refers to a solid material formed from a bulk solid (commonly called the aggregate) that is bound into the solid material with a binding material (commonly called cement). Cement and Concrete are amongst the most commonly used construction materials.

Chemical: As used in this disclosure, a chemical refers to a substance of a known or fixed composition. The term chemical is used to describe the substance when the details of the composition of the substance or properties of the substance are considered relevant to the disclosure at bar. The term properties is taken to mean both the measurable properties of the substance and the interactions of a first chemical with a second chemical. The term compound refers to: a) a chemical structure that comprises a one or more chemical bonds; or, b) a unified chemical structure formed from mixture of chemicals. The term compound is informally considered a synonym for the term chemical. The term chemistry refers to the study and the use of the knowledge of the composition and properties of chemicals. The terms chemical reaction refers to the interactions between two or more chemical structures. The reactants of a chemical reaction refer to the chemical structures used to initiate the chemical reactants. The products of a chemical reaction refer to the chemical structures that are present at the completion of the chemical reaction.

Chemical Bond: As used in this disclosure, a chemical bond refers to an attractive force between a first molecule or atom and a second molecule or atom. The primary bonds include, but are not limited to, covalent bonds, ionic bonds, and hydrogen bonds.

Colloidal Suspension: As used in this disclosure, a colloidal suspension, or colloid for short, is a heterogeneous mixture of solute particles dissolved in a solvent. The colloidal suspension is referred to as heterogeneous because the distribution of the solute particles is not uniform through the solvent, usually because of the relatively large size of the particles. When the solvent is a gas, a colloidal suspension is often referred to as an aerosol.

Covalent Bond: As used in this disclosure, a covalent bond refers to a chemical bond between a first atom and a second atom wherein the first atom and the second atom share each share one or more electrons with each other. This is in contrast to an ionic bond.

Copolymer: As used in this disclosure, a copolymer is a polymer formed from two or more repeating molecules (also referred to as monomers).

Environment: As used in this disclosure, an environment refers to the physical conditions surrounding an object. The term environment is often limited to the physical conditions that the object interacts with.

Fluorescence: As used in this disclosure, fluorescence is the emission of electromagnetic radiation, especially visible light, resulting from the absorption of stimulating radiation and persisting only so long as the stimulating radiation is continued. In a secondary usage, fluorescence will also refer to the electromagnetic radiation that is emitted as described above.

Fluorescent: As used in this disclosure, fluorescent is an adjective that is used to describe an object that exhibits or is capable of exhibiting fluorescence.

Hydrogen Bond: As used in this disclosure, a hydrogen bond refers to an electrostatic attraction between: 1) a cation and an anion; 2) a cation and a negative dipole; or, 3) an anion and a positive dipole. The exchange of electrons (as would occur in an ionic bond or covalent bond) does not occur in a hydrogen bond. As a rule, the energy to break an ionic bond is less that the energy required to break a covalent bond or an ionic bond.

Ion: As used in this disclosure, an ion is an atom or a molecule with a net electric charge.

Ionic Bond: As used within this disclosure, an ionic bond refers to a chemical bond between a first atom and a second atom wherein the first atom takes an electron from the second atom. This is in contrast to a covalent bond.

Iridescence: As used in this disclosure, iridescence refers to a source of reflected light wherein the wavelength of the reflected light changes as a function of the angle at which the source of the reflected light is viewed. The term iridescent is an adjective that is used to describe an object that exhibits or is capable of exhibiting iridescence.

Luminescence: As used in this disclosure, luminescence is the emission of light through phosphorescence, fluorescence or bioluminescence by processes that derive energy from non-thermal sources such as chemical, biochemical, crystallographic changes, and the motion of subatomic particles or the excitation of an atomic system by radiation. This definition explicitly excludes light generated through incandescence which is taken to be thermally generated visible radiation. The term luminescent is an adjective that is used to describe an object that exhibits or is capable of exhibiting luminescence.

Monomer: As used in this disclosure, a monomer refers to a molecular structure that bonds to itself in a repeating manner to form a polymer.

Organic: As used in this disclosure, organic refers to a carbon-based chemical structure. A limited number of carbon-based salts are traditionally considered inorganic chemical structures and are excluded from the study of organic chemistry.

Paste: As used in this disclosure, a paste is a fluid material with a viscosity such that the paste will appear as a soft or malleable solid. A paste is often formed as a viscous colloid.

Phosphorescence: As used in this disclosure, phosphorescence is the emission of electromagnetic radiation, especially visible light, resulting from the absorption of a stimulating radiation. Phosphorescence differs from fluorescence in that a phosphorescent emission will continue after the stimulating radiation has been discontinued.

Phosphorescent: As used in this disclosure, phosphorescent is an adjective that is used to describe an object that exhibits or is capable of exhibiting phosphorescence.

Pigment: As used in this disclosure, a pigment is a first material that is used to control the shade of a second material. Plasticity: As used in this disclosure, plasticity refers to a material that is easily shaped or molded.

Non-Polar Molecule: As used in this disclosure, a non-polar molecule refers to a molecular structure that: a) is electrically neutral; and, b) has a uniform spatial distribution of the electrons within the molecule.

Polar Molecule: As used in this disclosure, a polar molecule refers to a molecular structure that: a) is electrically neutral; but, b) does not have a uniform spatial distribution of the electrons within the molecule. A polar molecule will present one or more electrically positive poles and the same number of electrically negative poles within the molecular structure.

Polarity: As used in this disclosure, the term polarity is used to describe a physical property or physical characteristic wherein: 1) the physical property or physical characteristic manifests two opposing attributes, tendencies, characteristics, or principals; and, 2) the two opposing attributes, tendencies, characteristics, or principals have an intrinsic separation, alignment, or orientation.

Polymer: As used in this disclosure, a polymer refers to a molecular chain that comprises multiple repeating units known as monomers. The repeating unit may be an atom or a molecular structure.

Solution: As used in this disclosure, a solution is a uniform mixture of two or more compounds in a liquid phase. The major component selected from the two or more compounds that forms the solution is called the solvent. The components remaining in the two or more compounds are called the solute. A polar solvent is a solvent formed from polar molecules. A non-polar solvent is a solvent formed from non-polar molecules. The rule of thumb that “like dissolves like” states that: a) solutes formed from polar molecules will dissolve in polar solvents but will not dissolve in non-polar solvents; and, b) solutes formed from non-polar molecules will dissolve in non-polar solvents but will not dissolve in polar solvents.

Water: As used in this disclosure, water (CAS 7732-18-5) is a molecule comprising two hydrogen atoms and one oxygen molecule. The phase of water at normal temperature and pressure is liquid. As used in this disclosure, the definition of water is expanded to include dilute water-based solutions of salts and ionic structures using water as the solvent. Water in a gas phase is often referred to as steam. Water in a solid phase is often referred to as ice. Snow refers to a bulk solid form of ice.

Viscosity: As used in this disclosure, viscosity refers to the resistance of a liquid or an elastic material to deformation. Higher viscosity would refer to a greater resistance to flow or to deformation. The term centipoise refers to the units of measurement of viscosity in a liquid. In this disclosure: a) a viscosity of greater that 80 centipoise is considered a high viscosity; and, b) a viscosity of greater than 2000 centipoise is considered a gel like viscosity.

Viscous: As used in this disclosure, a viscous material is a material with a viscosity such that the viscous material has characteristics intermediate between a liquid and a solid.

Viscous Colloid: As used in this disclosure, a viscous colloid is a colloidal suspension where the viscosity or flow rate of the viscous colloid is such that the viscous colloid will flow but can for all practical purposes be treated and contained as if it were a solid. In common usages, a viscous colloid is often referred to as a cream or a paste.

With respect to the above description, it is to be realized that the optimum dimensional relationship for the various components of the invention described above and in FIGS. 1 through 4 include variations in size, materials, shape, form, function, and manner of operation, assembly and use, are deemed readily apparent and obvious to one skilled in the art, and all equivalent relationships to those illustrated in the drawings and described in the specification are intended to be encompassed by the invention.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

What is claimed is:

1. A viscous building material with phosphorescence comprising
a structural compound and a phosphorescent compound;
wherein the structural compound and the phosphorescent compound are mixed.

2. The viscous building material with phosphorescence according to claim 1
wherein the viscous building material with phosphorescence is a chemical compound;
wherein the viscous building material with phosphorescence is a composition of matter;
wherein the viscous building material with phosphorescence is formed as a viscous colloid.

3. The viscous building material with phosphorescence according to claim 2
wherein the viscous building material with phosphorescence is applied as a viscous fluid between two objects;
wherein the viscous building material with phosphorescence performs a structural function selected from the group consisting of: a) forming a fluid impermeable seal between the two objects; and, b) forming an adhesive seal that holds the two objects in a fixed position relative to each other;
wherein the viscous building material with phosphorescence illuminates in the dark.

4. The viscous building material with phosphorescence according to claim 3 wherein the structural compound and the phosphorescent compound are mixed to form the viscous colloid of the viscous building material with phosphorescence.

5. The viscous building material with phosphorescence according to claim 4 wherein the structural compound is a chemical compound;
wherein the structural compound is a viscous compound;
wherein the structural compound is the compound of the viscous building material with phosphorescence that performs the structural function of the viscous building material with phosphorescence;
wherein the structural compound is selected from the group consisting of: a) forming a fluid impermeable seal between the two objects; and, b) forming an adhesive seal that holds the two objects in a fixed position relative to each other.

6. The viscous building material with phosphorescence according to claim 5 wherein the phosphorescent pigment forms a colloidal suspension within the structural compound.

7. The viscous building material with phosphorescence according to claim 6
wherein the phosphorescent pigment is a phosphorescent material;
wherein the phosphorescent pigment is a bulk solid compound;
wherein the phosphorescent pigment is mixed directly into the structural compound;
wherein the molecular structure of the phosphorescent pigment absorbs electromagnetic radiation from the environment;
wherein the phosphorescent pigment releases the absorbed electromagnetic radiation back into the environment as electromagnetic radiation over time.

8. The viscous building material with phosphorescence according to claim 7
wherein the structural compound is selected from the group consisting of: a) a cement structure; and, b) a polymer structure;
wherein the cement structure is the structure that forms an adhesive seal that holds two objects in a fixed position relative to each other;
wherein the polymer structure is the structure that forms a fluid impermeable seal between two objects.

9. The viscous building material with phosphorescence according to claim 8
wherein the phosphorescent pigment is selected from the group consisting of: a) a zinc sulfide; and, b) a strontium aluminate;
wherein the phosphorescent pigment is selected such that the phosphorescent pigment continues to release electromagnetic radiation after the phosphorescent pigment is no longer exposed to electromagnetic radiation from the environment;
wherein the zinc sulfide is used to release a red to orange phosphorescence from the viscous building material with phosphorescence;
wherein the strontium aluminate is used to release a green to blue phosphorescence from the viscous building material with phosphorescence.

10. The viscous building material with phosphorescence according to claim 9
wherein the cement structure is a fluid phase viscous compound that is capable of flow;
wherein the cement structure changes into a solid phase compound when exposed to the environment;
wherein the polymer structure is a fluid phase viscous compound that is capable of flow;
wherein the polymer structure changes into a solid phase compound when exposed to the environment.

11. The viscous building material with phosphorescence according to claim 10
wherein the zinc sulfide is an ionic compound;
wherein the zinc sulfide is formed from bonding zinc with sulfate;
wherein the zinc sulfide exists in a bulk solid phase;
wherein the zinc sulfide is mixed into the structural compound;
wherein the zinc sulfide is a phosphorescent material;
wherein the strontium aluminate is an ionic compound;
wherein the strontium aluminate is formed from bonding strontium with aluminum oxide;
wherein the strontium aluminate exists in a bulk solid phase;
wherein the strontium aluminate is mixed into the structural compound;
wherein the strontium aluminate is a phosphorescent material.
